(19) United States
(12) Patent Application Publication
(10) Pub. No.: US 2009/0129905 A1
(43) Pub. Date: May 21, 2009

(54) PORTABLE END-TO-END INSTALLATION AND REMOVAL SERVICE LIFT TOOL FOR RACK MOUNTED IT EQUIPMENT

(75) Inventors: Steven C. McIntosh, Kingston, NY (US); Budy D. Notohardjono, Poughkeepsie, NY (US); Kevin R. Qualters, LaGrangeville, NY (US); Howard P. Welz, Highland, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/942,800

(22) Filed: Nov. 20, 2007

(51) Int. Cl. B62B 3/04; B60P 1/04; B62B 5/04

(52) U.S. Cl. 414/471; 180/19.1; 211/85.8; 280/79.3; 414/812

(57) ABSTRACT

A method and associated assembly is provided for installation and removal of electronic components on a computer rack. The assembly comprises a transport dolly with a platform and at least one caster and the Dolly is selectively sized to fit under or the computer rack. A Lift Tool is also provided and disposed over said Dolly. The Tool includes a lift platform capable for holding electronic components and a lift mechanism capable of moving from a first position to a second position such as to be capable of removing or disposing these components away or onto the rack. A plurality of Lift Rails are also provided that are storable between the Lift Tool and the Dolly. The Lift Rails can be used alone or assembled later into longer unitary units that attach to the rack and the Lift Tool in order to allow the Tool to transport the components from a first position to a second position along the rack.

### CROSS-REFERENCE TO RELATED APPLICATIONS

This application contains subject matter which is related to the subject matter of the co-pending application Ser. No. 11/782,703 which was filed on Jul. 25, 2007. That application which is hereby incorporated by reference in its entirety is also assigned to International Business Machines Corporation of Armonk, N.Y.

### BACKGROUND OF THE INVENTION

1. Field of the Invention

This invention relates to packaging of computing systems and more particularly to packaging of large computing systems having racks for housing electronic components.

2. Description of Background

The industry trend has been to continuously increase the number of electronic components inside computing systems. A computing system can include a simple personal computer, a network of simple computers, or one or even a network of large computers that include one or more central electronic systems (CEC). While increasing the components inside a simple computing system does create some challenges, however, such an increase create many problems in computing systems that include one or more large computers.

Traditionally, in large and sophisticated computing systems the electronic components, grouped together in electronic books and nodes, are placed on racks. The electronic books/nodes can include a number of elements including mother and daughter boards, logic elements, and even power supplies. The racks can be defined as cage like structures that provide the frame or housing of these systems. During installation and maintenance operations and procedures, the electronic books/nodes are hoisted into and out of these racks.

The continuous increase in the number of these components in recent years, have made this process difficult. The racks are often tall and the books/nodes are heavy. Sometimes, the size and depth of the racks themselves, designed to hold optimum number of components, is difficult to reach. In most cases, because of these issues more than one person needs to be employed for installation and maintenance procedures. Furthermore, a variety of equipments, such as cranes and hoists, may be necessary to complete these procedures. Not only the use of this equipment add delay and cost to the operation, but they increase the degree of complexity of the procedure itself which have become cumbersome to complete. In addition, the use of such equipment involves locating them, transporting them and storing them. The above mentioned dependencies have greatly affected the cost of the service and installation of these systems. Moreover, the difficulty in performing these installation and service procedures have caused unwanted delays and affected system availability at crucial times.

In the cross-referenced application, an end-to-end solution was provided that simplified installation and service procedures using a Tool Lift. The present invention provides further improvements to that design and enhances the end-to-end solution.

### SUMMARY OF THE INVENTION

The shortcomings of the prior art are overcome and additional advantages are provided through the provision of a method and associated assembly for installation and removal of electronic components on a computer rack. The assembly comprises a Transport Dolly with a platform and at least one caster. The Dolly is selectively sized to fit under or inside the computer rack. A Lift Tool is also provided and disposed over said Dolly. The Tool includes a lift platform capable of holding electronic components and a lift mechanism capable of moving from a first position to a second position such as to be capable of removing or depositing these components away or onto the rack. One or more Lift Rails are also provided that is storable between the Lift Tool and the Dolly. The Lift Rails can be used alone or assembled later into longer unitary units that attach to the rack and the Lift Tool in order to allow the Tool to transport the components from a first position to a second position along the rack.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is an illustration of a multipurpose rack or frame as used in one embodiment of the present invention;

FIG. 2 is an perspective side view illustration of an assembled Transport Dolly and Lift Tool as per one embodiment of the present invention;

FIG. 3 is an exploded perspective side view illustration of different components of the Transport Dolly and Lift Tool of FIG. 2;

FIG. 4 is an illustration of the Lift Tool as attached to the rack of FIG. 1;

FIG. 5 is an illustration of details of different as provided in the embodiment of FIG. 4;

FIG. 6 is an illustration of the Lift Shelf as per embodiment of FIG. 5; and

FIG. 7 illustrates the operation of Lift Tool as per embodiment of FIG. 4.

### DESCRIPTION OF THE INVENTION

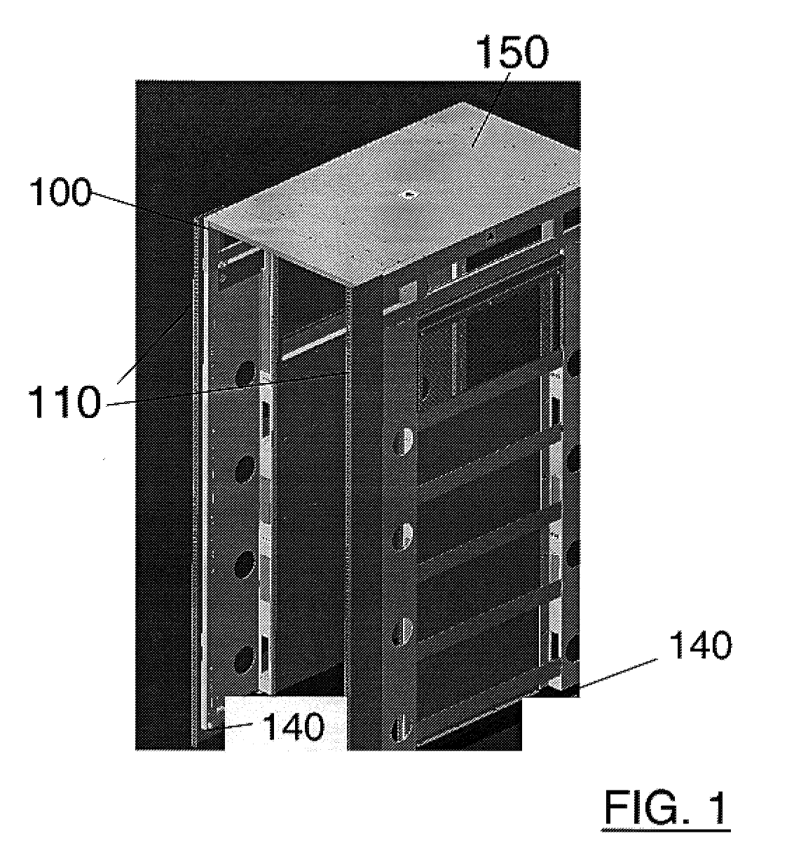

FIG. 1 is an illustration of a computer housing, preferably comprising a rack or frame. The computer housing, or computer rack, is referenced by numerals 100 in the figure. The computer rack house electronic components such as used in servers and other large computing system environments. The rack 100 comprises a top and bottom surface, referenced respectively by numerals 150 and 140. It also comprises sides 110 as shown in the figure.

The rack 100 as provided by the illustrated figure has a cage like structure. However, this structure is only provided as way of example and other arrangements and rack designs can be used in conjunction with the teachings of the present invention. In addition, although the rack or frame 100 as shown does not include any side enclosures such as front and rear doors, side covers. Covers and doors can be added selectively to all or parts of the housing/rack 100.

The electronic components as discussed are often placed on the rack as part of electronic books/nodes. These electronic books or nodes, therefore, can include mother and daughter boards, logic elements and a variety of other components.

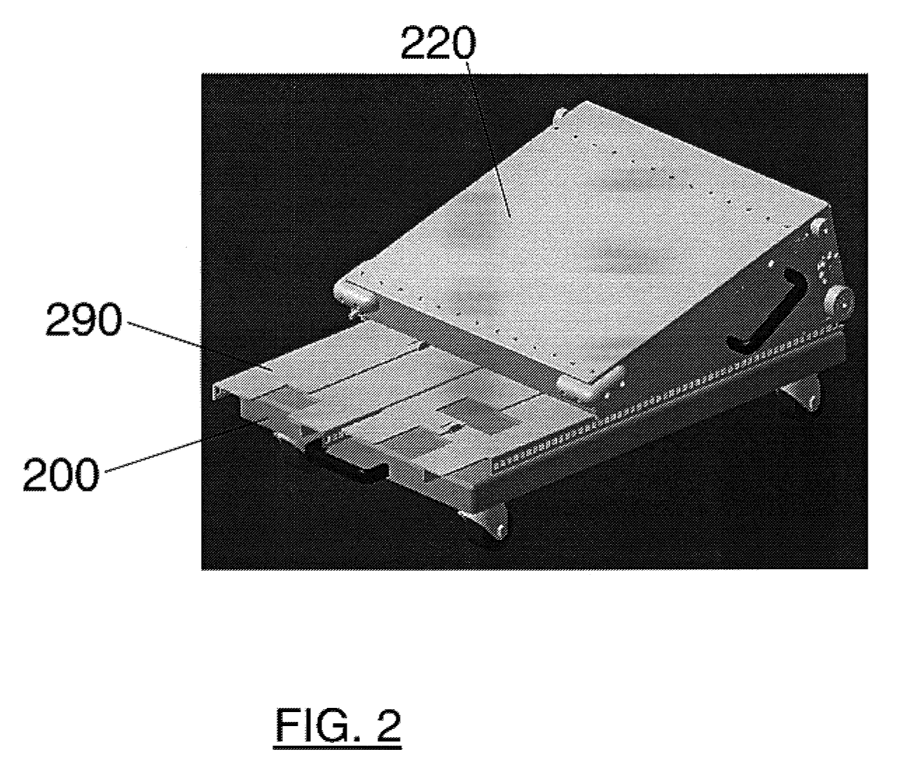

FIG. 2 is a perspective illustration of one embodiment of the present invention. In this embodiment, a combination Transport Dolly and Lift Tool is provided. The Transport Dolly is referenced by numerals 200 while the Lift Tool is referenced by numerals 210. In addition, a plurality of Lift Rails 290, are provided to easily allow the Lift Tool 210 to be mounted securely to the Dolly 200 as shown and later rack 100. The Lift rails can be stored between the Dolly 200 and the Lift Tool 210.

As will be discussed in greater detail below, the Dolly/Lift Tool combination of FIG. 2 provides a design that is directly compatible with computer racks such as the one discussed in FIG. 1 (i.e. 100) and packing materials to provide a means for transferring, transporting and servicing IT equipment. The design allows a one person operation and provides for easy location, storage and/or transportation of it (such as in a standard vehicle when desired). The compact design of the combination also allows it to be used for a tight area application.

The multiple items as provided in FIG. 2 and later figures below provide an end-to-end service tool that is packaged into a compact, portable kit. This is rather important design feature. More and more computers are being stored in tight spaces such as inside an air-plane or even inside a destroyer\ship where the storage and maneuverability is critical. This is a great improvement over the prior art designs that always need large working areas for proper operation.

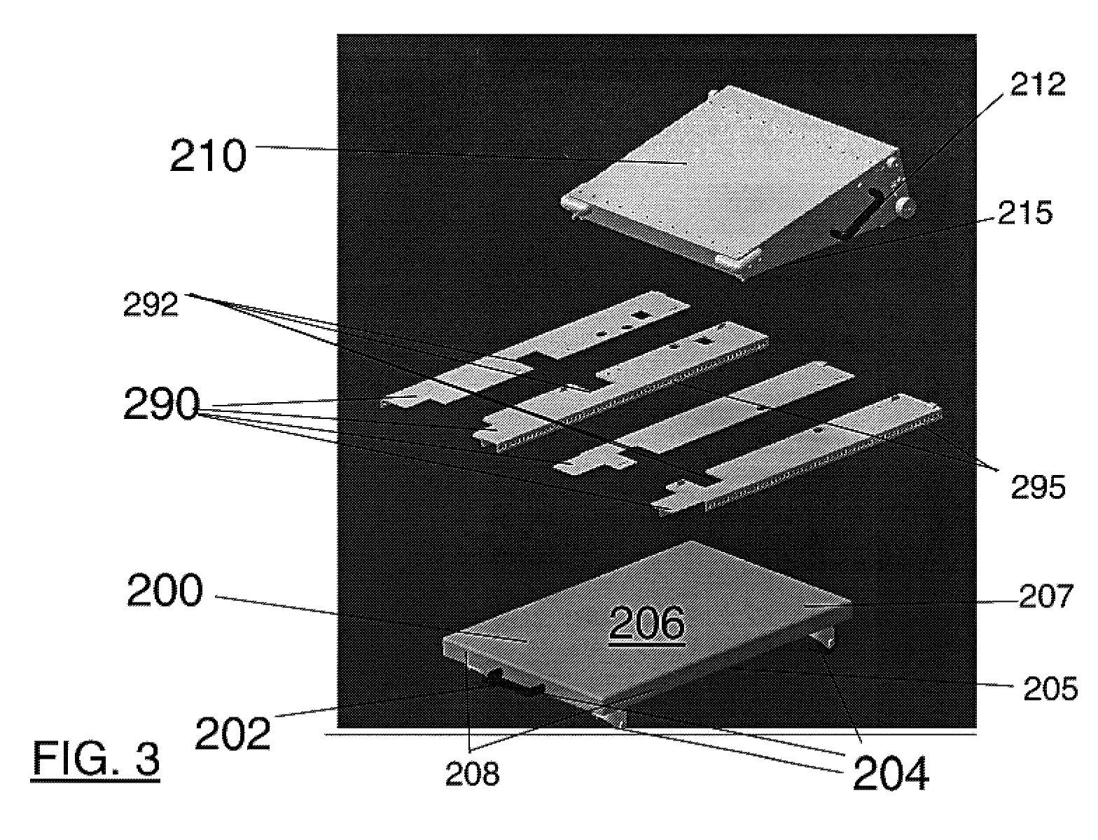

In FIG. 3, an exploded perspective side view of different elements of the embodiment of FIG. 2 is provided. The depicted exploded view illustrates the Transport Dolly 200, segmented Lift Rails 290 and a Lift Tool 210 having a Tool Shelf.

The Transport Dolly 200 comprises a platform portion, referenced as 206. The platform portion includes a top and bottom surface, referenced respectively as 207 and 205 and sides 208. The platform portion 206 of the Transport Dolly 200 can be selectively sized to accommodate the heaviest and largest equipment (i.e. such as information technology or IT equipment) that is used for large class environment that include one or more servers.

The Transport Dolly 200 serves as the base for the Lift Tool (Kit) 210. In an alternate embodiment, the platform portion 206 includes a series of attachment points as known to those skilled in the art. (It should be noted that the attachment features can be used to attach any custom hardware, and to also secure the other items when the Lift Tool Kit is not in use.) In addition the platform can be fabricated out of or include one or a plurality of a low-friction surface components as known to those skilled in the art.

The Transport Dolly 200 further includes one or even a combination of casters that can selectively either be fixed and/or made to swivel. The casters are shown in the figure by referenced numerals 204. It should be noted that for ease of understanding, a preferred embodiment example is shown that incorporates four casters 204 (one not visible) in the figure. However, in alternate embodiments, as few as one caster can be used. It is also possible to use a plurality of casters that are fewer or more than the four casters shown in the example.

In addition, in one embodiment, the casters 204 are sized in accordance with the desired maneuverability and load capacity. Since in one embodiment, as will be discussed later, the Transport Dolly 200 can be stored in the rack, the casters 204 in such an embodiment need to be designed in number and size to allow for that situation.

Furthermore, optional handle(s) 202 can be incorporated into the Transport Dolly design as shown in the example. This is to allow for easy transport. The handle can come in other designs as known to those skilled in the art. For example, the handle can be a bar, or be shaped as shown but further include additional straps or components such as longer handles that can be used to pull the dolly along the floor.

In one embodiment, the overall height of the Transport Dolly is selectively controlled so that items can be easily transferred between the dolly and both the Lift Shelf and any packaging materials without requiring that these be manually lifted and set in place. (The caster/Dolly height also can be permanently fixed or transient.) For example, it is possible to have retractable casters 204 that can be extended from a first position to multiple other positions to optimize storage and any particular engagement and/or height requirements. In addition, each caster position can include a locking mechanism that ensures the particular position is held for as long as desired. As these features are known to those skilled in the art, a further and separate discussion of them are not made herein.

In a preferred embodiment as shown, the Dolly 200 is rectangular in shape with four casters being mounted under each corner of the rectangle. In any case the Dolly is always designed to be complementary to the shape of the rack and the Tool Lift 210. Therefore, it is possible in alternate embodiments, when it is appropriate to satisfy this last requirement for the Dolly to have alternate shapes and for the casters to be placed such that they optimize transportation of the Lift Tool 200 and also its later storage under the rack 100.

Referring back to FIG. 3, a plurality of Lift Rails 290 is also provided. In the embodiment shown, the rails are segmented and can later be assembled. The rails can be stored easily between the Dolly 200 and the Tool 210 as was shown in FIG. 2. Once the Dolly and the Tool are disengaged, in this case, they will then be reassembled together to make one or more unitary lifting rails which will ultimately connect to the rack sides.

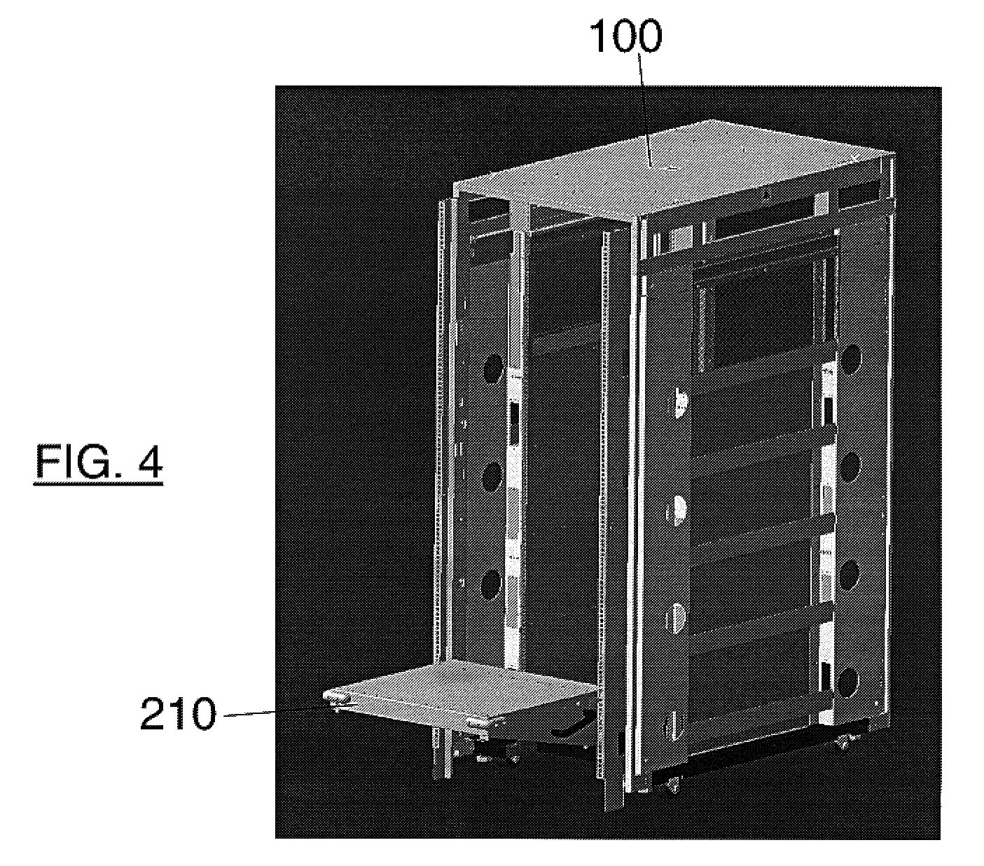

In addition, the rails 290 can serve dual purpose. In their first capacity, such as represented in FIG. 2, when the Dolly 200 needs to be securely attached to the Lift Tool 210, they can be used for that purpose. The Tool will then be disposed onto or off of the Dolly such as by a sliding motion (although other alternative embodiments can be provided such as known to those skilled in the art). The rails will then be secured to the top of the Dolly platform 207 or the bottom of the Tool as referenced by 215. It should be noted that the rails 290 have components 292 that are complementary to one another and can be made to easily fit one another as when needed to be used in their second capacity. In addition, while in FIG. 4 Rails are demonstrated for ease of understanding it is possible to use as few as one rail or increase or decrease the number in any manner from the four demonstrated herein the figure.

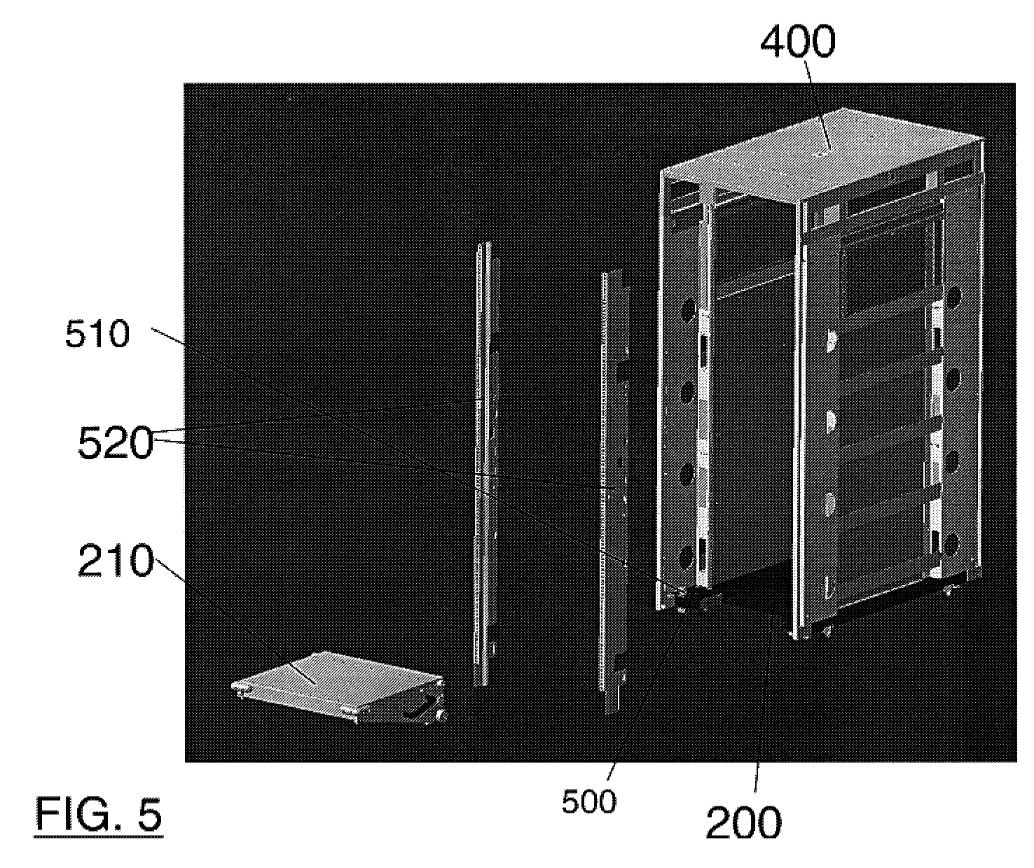

In their second capacity, the Lift Rails 290 can also be designed such that they can attach directly to the computer rack 100. In this case, they can include a channel and a series of notches that are compatible with the Lift Shelf roller bearings and sprockets as shown in later figures. In one embodiment, the rails are segmented so that they can easily fit on the Transport Dolly without driving an increase in the effective size of the kit. When in use, these Lift Rails are aligned to the corner posts of the computer rack via alignment features, and are secured using captive fasteners (not shown). The Lift Rails span the full useable height of any desired rack, giving the Lift Shelf access to virtually any rack-mount devices. This is shown better in the illustration of FIG. 5. To distinguish between the dual capacity of the rails, in this figure they are represented by reference numerals 520 as shown. The lift rail 520 can also include a channel and a series of notches (previously shown as 292) that are designed to interface with the lift shelf 530, but this design is only optional. The lift rail 520 can be used with any type of rack. The mounting of the lift rail to the rack is accomplished by a variety of methods as known to those skilled in the art that can include its mounting via fasteners at the top, mid point and bottom of the lift rail.

It should be noted that the lift rails 520, are preferably designed to be compatible with the computer rack 100 such that the rails are aligned and mechanically fastened to either the front or rear corner posts of the computer rack. Each lift rail 520 may either be a single unit that spans the entire height of the rack, or can alternatively be broken up into multiple interlocking segments which are smaller and easier to store and handle.

FIG. 4 is an illustration of the assembled Dolly/Lift Tool such as the one discussed in conjunction with FIGS. 2 and 3 secured to a computer rack such as the rack 100 of FIG. 1. As can be seen, Lift Tool assembly as shown can be used by one person to easily install and or remove components from the rack. The Lift Tool 210 can be moved as shown in the figure and a lift mechanism, from a first position into a second position (or alternatively other—third and fourth positions) to allow objects to be hoisted and disposed into and out of the rack 100. The rails can be attached to the sides of the rack to enable the securement of the Lift Tool 210 and aid the disposing as discussed earlier.

Also as shown in this figure, the Dolly itself is placed inside the rack 100 for easy storage. In one embodiment, the Dolly 200 can have means to attach it to the inside (such as walls) of the rack 100, representatively referenced as 500 and further locking means referenced as 510. These securing and locking means can be any of the ones known to those skilled in the art (including rails, bolts, screws and the like.)

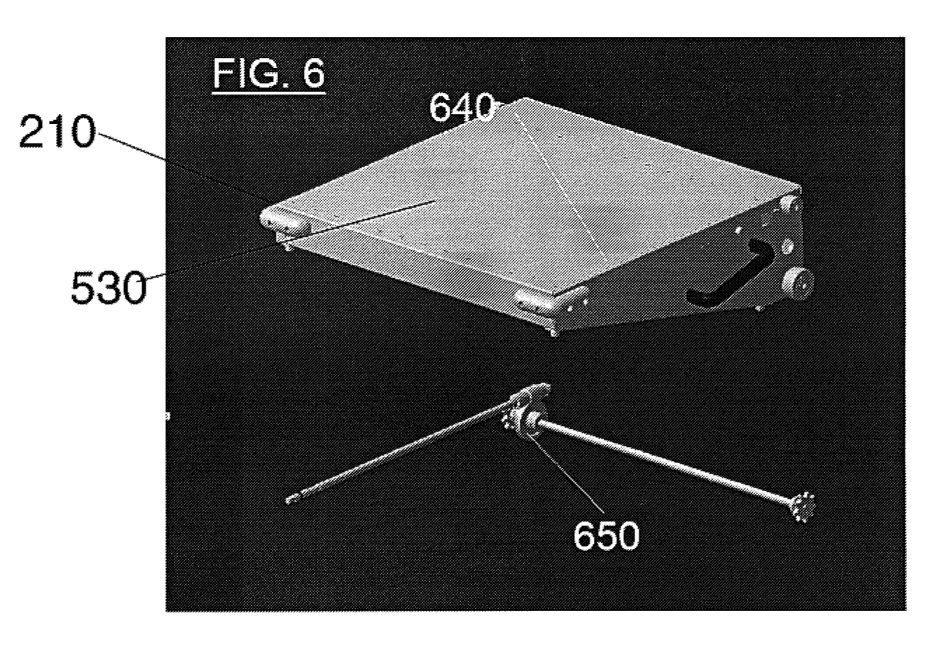

FIG. 6 provides is an illustrative perspective view that further identifies the different components that comprise the Lift Tool 210. The lift tool 210 comprises of a lift shelf 530, which in turn includes a lift platform 640 and a lift mechanism 650. The lift platform 640 can be comprised of a low friction material to allow for heavy objects to be easily transferred on and off the platform. The platform 640 can further comprise a series of mounting features that can selectively accommodate any number of custom hardware products, as known to those skilled in the art such as guides, slides, and intermediate transfer shelves that would be required to service unique devices or for other selective needs and purposes.

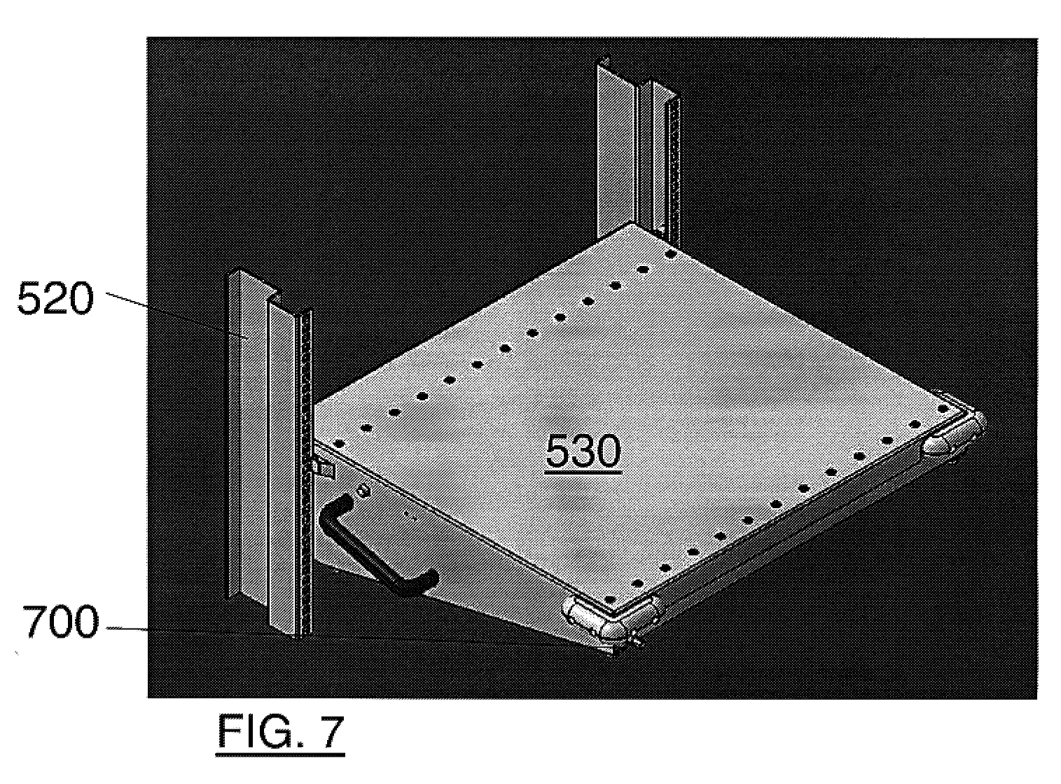

The lift mechanism 650 can be further comprised of a sprocket and roller bearings on each side of the lift shelf. Working in concert with the lift rails, these sprockets and bearings allow the shelf to travel directionally, preferably in an up and down direction. As illustrated in FIG. 7, when assembled, the lift shelf 530 can be cranked directionally, preferably in an up and down direction, by way of a user operated drive shaft 700 that controls the sprockets.

Taking the figures together, therefore, in one embodiment the installation and removal of electronic components onto and away from the computer rack can be achieved by first aligning the Lift Tool that is disposed over the Transport Dolly in such a way that the transportation of the books can be achieved. The Dolly and the Lift Tool can then be disengaged and the plurality of segmented Lift Rails disposed between them can be assembled into at least one single unitary Lift Rails and preferably two unitary Lift Rails. The Rail(s) are then attached to the side of the rack and to the Tool Lift such that the Lift can be moved from a first position to a second position along the rack using its Lift Mechanism. (The Lift Shelf can be used to easily transport the books). The Dolly can be stored under the rack when it is no longer being used and its casters and locking mechanism can also be used to optimize its storage.

Today's IT solutions are driven by price/performance, packaging density, scalability, and availability. To satisfy these industry needs, the building blocks that are used in large computing environments are complex, and powerful. Yet these very systems must also be easy to service and upgrade in a timely manner. Providing systems that are hard to service or install have impacted customer satisfaction and speed of doing business. The present invention provides ways that when incorporated will greatly improve availability by minimizing the time required to service or install these large systems.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An installation and removal assembly used for disposing electronic components onto or away from a computer rack comprising:
a transport dolly having a platform and at least one caster; said dolly selectively sized to fit under or inside said computer rack;
a lift tool capable of being securely disposed over said dolly;
said lift tool having a lift platform for holding electronic components and a lift mechanism for moving said tool from a first position to a second position along said rack;
a plurality of lift rails storable between said lift tool and said dolly;
at least one lift rail having means to attach to said lift tool and said rack to allow said tool to move from a first position to a second position along said rack using its lift mechanism.

2. The assembly of claim 1 wherein a plurality of rails are used.

3. The assembly of claim 1 wherein said casters swivel.

4. The assembly of claim 1 wherein said rails are also used to securely attach said lift tool to said dolly.

5. The assembly of claim 1 wherein said dolly has means to secure it to said computer rack.

6. The assembly of claim 5 wherein said dolly also has locking means to attach it more permanently to said rack once it is secured.

7. The assembly of claim 1 wherein said casters are retractable and said dolly further includes a handle.

8. The assembly of claim 1 wherein said casters can be retracted from a first position to multiple positions to allow height adjustment for the dolly.

9. The assembly of claim 1 wherein said dolly has a platform and sides and said rails and said lift tool are disposed on said dolly platform.

10. The assembly of claim 9 wherein said platform is made from a low friction surface.

11. The assembly of claim 9 wherein at lest one low-friction attachment is secured to said platform.

12. The assembly of claim 1 wherein said lift rails are aligned and mechanically fastened to either front or rear corner posts of said computer rack.

13. The assembly of claim 2 wherein each lift rail is comprised of a variety of interlocking segments.

14. The assembly of claim 13 wherein when said lift rails are assembled they form at least one single unitary rail that spans entire height of said rack.

15. The assembly of claim 1 wherein said rails include a channel and a series of notches that are designed to interface with said lift shelf.

16. The assembly of claim 1 wherein said lift mechanism further comprises a sprocket and roller bearings placed on each side of said lift shelf such that when working in concert with said lift rails, said sprocket and bearings allow said shelf to travel directionally in an up and down direction.

17. The assembly of claim 16 wherein said lift shelf further comprises a drive shaft to allow it to be cranked directionally; said drive shaft also controlling said sprocket(s).

18. The assembly of claim 1 wherein said dolly and its said platform is rectangular in shape and said dolly has four casters mounted underneath said platform substantially under each platform's corner.

19. A transport dolly used for disposing electronic components on a computer rack comprising:
a rectangular platform having four corners and a plurality of retractable casters mounted underneath each of said corners;
a plurality of rails mounted on a top surface of said platform; said rails capable of fitting together to make a unitary rail;
means for allowing said dolly to be engageably attached to a tool lift used to hoist elements on said rack;
said dolly being selectively sized and including means to engageably attach it to said rack when not in use, such that said dolly fits substantially under such rack and can be transported and/or moved with said rack; and
a dolly handle for aiding said dolly's transportation.

20. A method of installation and removal of electronic components onto a computer rack comprising the steps:
aligning a lift tool disposed over a transport dolly with retractable casters such that electronic books can be disposed onto or removed from said rack;
said lift tool having a lift platform and a lift mechanism for allowing said lift tool to transport electronic books and for it to move from a first position to a second position;
assembling a plurality of segmented lift rails disposed between said dolly and said lift tool into single unitary lift rails;
attaching at least one single unitary lift rail to said rack such that electronic moves can be disposed or removed by said lift tool moving from a first position to a second position along said rack using said lift rail and said lift mechanism; and
storing said transport dolly under said rack when said dolly is no longer being used.
